(19) United States
(12) Patent Application Publication
(10) Pub. No.: US 2014/0089494 A1
(43) Pub. Date: Mar. 27, 2014

(54) MANAGING COMPLIANCE ACROSS INFORMATION TECHNOLOGY COMPONENTS

(71) Applicant: HEWLETT-PACKARD DEVELOPMENT COMPANY, L.P., Houston, TX (US)

(72) Inventors: Rajashekar Dasari, Hyderabad (IN); Vedala Phani Kumar, Bangalore (IN); Bezawada Suresh, Hyderabad (IN)

(73) Assignee: HEWLETT-PACKARD DEVELOPMENT COMPANY, L.P., Houston, TX (US)

(21) Appl. No.: 13/687,942

(22) Filed: Nov. 28, 2012

(30) Foreign Application Priority Data
Sep. 27, 2012 (IN) 4015/CHE/2012

(51) Int. Cl. H04L 12/26

(52) U.S. Cl. CPC H04L 12/2602
USPC 709/224

(57) ABSTRACT

Provided is a method of managing compliance across information technology components. A policy requiring compliance is identified, and information technology components required for determining compliance of the policy are identified from the policy. Data is obtained from the information technology components and analyzed for determining compliance of the policy.

### BACKGROUND

A typical information technology (IT) infrastructure, such as data center, of an enterprise may include multiple information technology components such as servers, computer systems, network switches, storage devices, storage area network, computer applications, etc. These infrastructure resources are not only expected to provide a certain level of performance as part of a Service Level Agreement (SLA), but also required to comply with policy imperatives of an enterprise or its customer.

### BRIEF DESCRIPTION OF THE DRAWINGS

For a better understanding of the solution, embodiments will now be described, purely by way of example, with reference to the accompanying drawings, in which:

FIG. 1 is a schematic diagram of an information technology (IT) infrastructure, according to an example.

FIG. 2 shows a block diagram of a compliance module hosted at a computer system, according to an example.

FIG. 3 illustrates a flow chart of a method of managing compliance across information technology components, according to an embodiment.

### DETAILED DESCRIPTION OF THE INVENTION

In today's competitive environment, organizations may spend a significant amount of their financial resources in creating an information technology (IT) infrastructure that helps them differentiate their products and services from their competitors. This IT infrastructure may include data centers, computers, servers, computer networks, database management tools, routers, etc. Generally speaking, an IT infrastructure may be viewed as everything that supports the flow and processing of information. Considering the investments made in creating an IT infrastructure, an enterprise (or its clients) may expect a certain level of performance from the IT components or elements deployed in an IT infrastructure. Typically, these expectations form part a Service Level Agreement (SLA). In addition to performance requirements, enterprises also expect these tools to comply with certain policies or standards. These policies could be defined by the enterprise or demanded by its customers. Some non-limiting examples of these policies may include a security policy, a message origination policy, a message delivery policy, an event generation policy, a fault message policy, an error policy, a login policy, a system validation policy, etc.

Typically, policy or SLA compliance of an IT component is monitored by obtaining relevant data from the component and then evaluating this data against a pre-defined policy or SLA. If the IT component does not comply with a policy or SLA a non-compliance event message is generated which is reported to an IT or system administrator. This evaluation mechanism which could be appropriate for a handful of IT components in an IT infrastructure (since manual monitoring for compliance may be possible) would be ineffective if the number of components in an IT infrastructure increases to a large number. For example, if there are multiple servers, computer applications, network components (like routers and network switches), etc. In this situation, it is very difficult to monitor policy or SLA compliance for all or most IT components. The situation may be further compounded if a policy or SLA compliance requires data or information from a plurality of components. For example, there may be a policy requirement that may require data from a plurality of servers as well as network components, for instance in the case of a large data center. Policy compliance in this case may require data from cross grouped products. In such circumstances, it's challenging to find out cross grouped information and verify that the enterprise level compliant policies are adhered. For instance, if an administrator has to verify whether a server is backed or not in a backup manager, it is a very tedious task if the administrator has to do this process for a large number of servers. Keeping track of these tasks would not only be mundane but also error prone.

Proposed is a solution that avoids the mundane and tedious task of manually verifying compliance policies. The proposed solution validates data across IT products in an intelligent way. In an example, the proposed solution automatically extracts data from various cross groups based on pre-defined policies and alert administrators on the compliance status of its IT components (such as servers, computer applications, etc.).

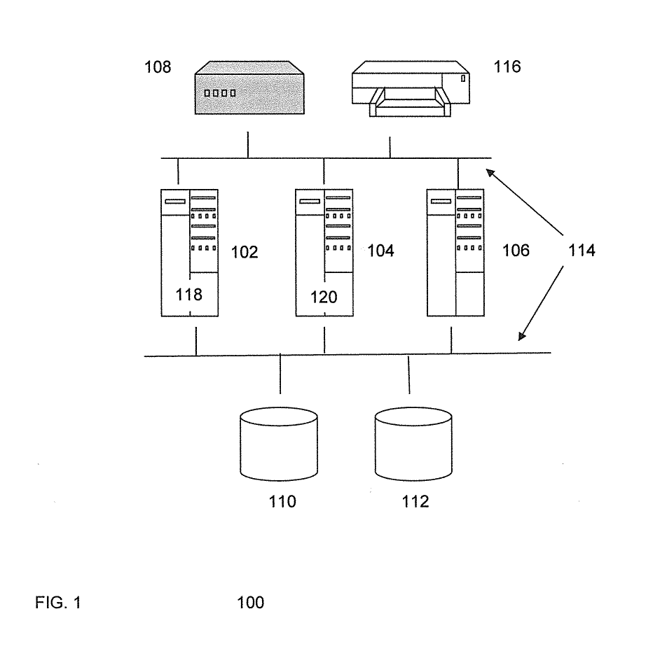

FIG. 1 is a schematic diagram of an information technology (IT) infrastructure 100, according to an example. Information technology infrastructure 100 is an example illustration of a typical IT infrastructure which may be deployed by an enterprise for its information management requirements. For instance, information technology infrastructure 100 could be a data center serving data storage or application hosting requirements of an enterprise.

Information technology infrastructure 100 comprises of various information technology components or elements such as server computers 102, 104, 106, network switch 108, storage devices 110, 112, network 114, printer 116, and computer applications (machine executable instructions) 118, 120. It should be noted that aforementioned components are merely illustrative (i.e. without any limitation) and information technology infrastructure 100 may include additional types of information technology components such as routers, scanners, multi-functional devices, etc. The number of information technology components shown in FIG. 1 is also merely illustrative and information technology infrastructure 100 may include additional numbers of information technology components (such as additional server computers, network switches, storage devices, printers, etc.).

Information technology components (such as server computers 102, 104, 106, network switch 108, storage devices 110, 112 etc.) of information technology infrastructure 100 could be connected to each other through network 114, such as an Ethernet, local area network (LAN), a wide area network (WAN), the internet, and the like. Network 114 may be physical (for example, co-axial cable) or wireless (for example, Wi-Fi).

Server computers 102, 104, 106 are computers or computer applications (machine executable instructions) that provide services to other computers or computer applications. Depending on the computing service that it offers server computers 102, 104, 106 could be database servers, print servers, web servers, gaming servers, file servers, mail servers, or some other kind of servers.

Network switch 108 is a computer networking device that connects network segments or network devices. Network switch 108 may be an unmanaged switch, managed switch, smart switch, or an enterprise managed switch.

Storage devices 110, 112, are computing devices capable of electronic or digital data storage, such as, but not limited to, tape drives, disk drives, disk array, optical discs (such as, CD, DVD and Blu-ray disc) and redundant array of independent disks (RAID).

Computer applications 118, 120 are computer software designed to help the user to perform specific tasks. Examples may include enterprise software, network management software, accounting software, office suites, graphics software, etc. In an implementation, computer applications may be present on host computers such server computers 102, 104, 106, network switch 108, storage devices 110, 112, etc. For example, in FIG. 1, computer applications 118 and 120 are hosted on computer servers 102 and 104 respectively.

Information technology components of information technology (IT) infrastructure 100 may have to comply with a policy (or policies) or a Service Level Agreement(s) (SLA). These policies may be defined by an enterprise (that owns the IT infrastructure) or by a customer of the enterprise. In an example, a compliance policy or SLA could be in the form of a computer program (machine executable instructions) which may be hosted on a component or element of an information technology infrastructure such as server computer 102 or network switch 108.

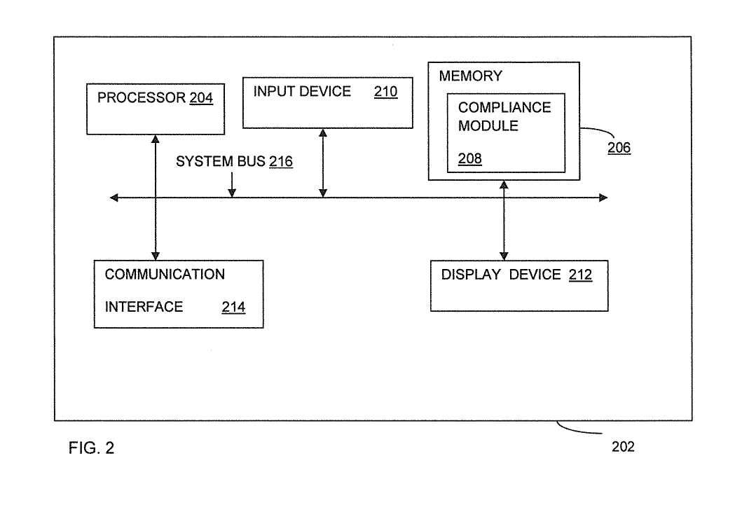

FIG. 2 shows a block diagram of a compliance module hosted at a computer system 202, according to an example.

Computer system 202 may be a computer server, desktop computer, notebook computer, tablet computer, mobile phone, personal digital assistant (PDA), or the like.

Computer system 202 may include processor 204, memory 206, compliance module 208, input device 210, display device 212, and a communication interface 214. The components of the computing system 202 may be coupled together through a system bus 216.

Processor 204 may include any type of processor, microprocessor, or processing logic that interprets and executes instructions.

Memory 206 may include a random access memory (RAM) or another type of dynamic storage device that may store information and instructions non-transitorily for execution by processor 204. For example, memory 206 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 206 may include instructions that when executed by processor 204 implement compliance module 208.

Compliance module 208, in an implementation, identifies a policy (or Service Level Agreement, standard, or rule) that requires compliance in an information technology infrastructure, identifies information technology components that are required for obtaining data for policy compliance, obtains data from the information technology components, and generates a policy compliance report based on the data obtained earlier.

Compliance module 208 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, compliance 208 may be read into memory 206 from another computer-readable medium, such as data storage device, or from another device via communication interface 216.

Input device 210 may include a keyboard, a mouse, a touch-screen, or other input device. Display device 212 may include a liquid crystal display (LCD), a light-emitting diode (LED) display, a plasma display panel, a television, a computer monitor, and the like.

Communication interface 214 may include any transceiver-like mechanism that enables computing device 202 to communicate with other devices and/or systems via a communication link. Communication interface 214 may be a software program, a hard ware, a firmware, or any combination thereof. Communication interface 214 may provide communication through the use of either or both physical and wireless communication links. To provide a few non-limiting examples, communication interface 214 may be an Ethernet card, a modem, an integrated services digital network (“ISDN”) card, etc.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

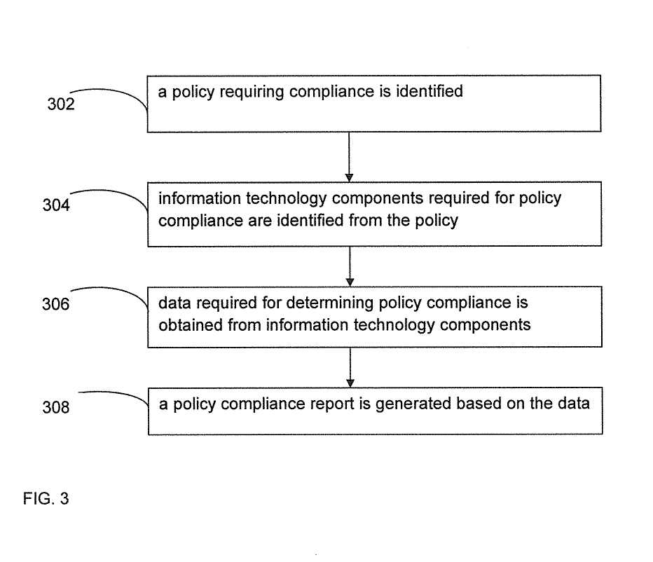

FIG. 3 illustrates a flow chart of a method of managing compliance across information technology components, according to an embodiment.

The method may be implemented in an information technology component of an information technology infrastructure such as information technology infrastructure 100 illustrated in FIG. 1. For example, the method may be implemented in server computers 102, 104, 106 network switch 108, storage devices 110, 112, network 114, and/or printer 116. In an implementation, the method may be implemented in a computing device which may be external to an information technology infrastructure. The method may be implemented in the form of a computer application (machine readable instructions which are executable by a processor) or module. In one example, the method may be implemented as part of a Server Automation (SA) application or as a separate module.

At block 302, a policy (or Service Level Agreement, standard, or rule) requiring compliance in an information technology infrastructure is identified. The policy could be located in any information technology component of an information technology infrastructure. Said differently, the policy may be present on one or a plurality of information technology components. Some non-limiting examples of a policy may include a security policy, a message origination policy, a backup policy, a message delivery policy, an event generation policy, a fault message policy, an error policy, a login policy, a system validation policy, etc. A policy could be defined by an information technology component or it may be user defined. In an implementation, identifying a policy requiring compliance includes identifying a policy requiring compliance across a plurality of information technology components.

In an implementation, a policy requiring compliance is a “cross-product” policy. A “cross-product” policy is a policy that requires data from more than one or a plurality of information technology products (or components) for compliance. The aforesaid information technology products could be similar (for example, all of them may be server computers) or they could be different (for example, they could be a mix of server computers, network switches, routers, storage devices, etc.). An illustration of a “cross-product” policy could be a server backup policy that requires data from a server computer “A”, a storage device “B”, and a computer application “C”. It's only when the relevant data from aforementioned information technology components is available that an evaluation could be made regarding compliance of the server backup policy.

At block 304, information technology components that are required for obtaining data for policy compliance are identified from the policy. In other words, the policy identified at block 302 is evaluated to identify those information technology components from which data would be necessary for determining whether the policy is being complied or not. To provide an example, in the context of an earlier illustration, server computer “A”, storage device “B”, and computer application “C” may be identified from the server backup policy mentioned above. An analysis of the policy is made to identify (from the policy itself) those information technology components that are needed for obtaining data required for ensuring policy compliance.

In an implementation, a user may at the time of defining a policy may characterize information technology components that are needed for monitoring compliance of the policy. The required information technology components are identified in the policy itself. To provide an illustration, a user may create the following policy that identifies (or provides clues to) the information technology components required for obtaining data for policy compliance: “FSRM Volume details with Extensions for Server 1 (SE1) with backup data from SA database”. In this case, the proposed solution would identify Server 1 and SA database as information technology components that need to be accessed for obtaining the relevant policy compliance data. Therefore, based on this policy, the data related to FSRM_VOLUME_INFO and FSRM_EXT_DETAILS will be fetched from SE1 along with backup data from SA database. The data obtained would be evaluated for policy compliance. In an implementation, identifying the policy requiring compliance across a plurality of information technology components includes analyzing said policy to identify information technology components mentioned therein.

In another implementation if an information technology component that is required for obtaining data for policy compliance does not have data in a required format, a user may create a necessary format for capturing data from the information technology component.

At block 306, data is obtained from the information technology components identified at block 306. The data obtained could be directly relevant for determining compliance of the policy or the data may have to be processed for obtaining information pertinent to ensuring compliance. To provide an example, in the context of an earlier illustration, data may be obtained from server computer “A”, storage device “B”, and computer application “C” for determining compliance of the server backup policy mentioned earlier.

At block 308, data obtained at block 306 is analyzed and a policy compliance report is generated based on the data. The compliance report indicates whether a policy is being complied in an information technology infrastructure or not. The policy compliance report may also identify the information technology components that are compliant or non-complaint with a policy. The compliance report could be shared with a system administrator (or an information technology infrastructure manager or another user) for an appropriate action, if required. In an implementation, a system event may also be generated notifying (the administrator, for instance) whether a policy is complaint or non-compliant.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of managing compliance across information technology components, comprising:
identifying a policy requiring compliance;
identifying, from the policy, information technology components required for determining policy compliance;
obtaining data from the information technology components; and
analyzing the data for determining compliance of the policy.

2. The method of claim 1, wherein the policy requires compliance across a plurality of information technology components.

3. The method of claim 1, wherein the policy is present on one or a plurality of is information technology components.

4. The method of claim 1, further comprising characterizing the information technology components required for policy compliance in the policy itself.

5. The method of claim 1, further comprising generating a policy compliance report based on analysis of the data obtained from the information technology components required for policy compliance.

6. The method of claim 5, wherein the policy compliance report identifies the information technology components that are compliant or non-complaint with the policy.

7. The method of claim 1, further comprising generating a system event notifying whether the policy is complaint or non-compliant.

8. The method of claim 1, wherein identifying the policy requiring compliance includes identifying a policy requiring compliance across a plurality of information technology components.

9. The method of claim 8, wherein identifying the policy requiring compliance across the plurality of information technology components includes analyzing said policy to identify information technology components mentioned therein.

10. A computing system, comprising:
a compliance module, wherein the compliance module:
identifies a policy requiring compliance;
identifies, from the policy, information technology components for obtaining data for policy compliance;
obtains and analyses data from the information technology components for is determining compliance of the policy.

11. The system of claim 10, wherein the compliance module generates a policy compliance report based on analysis of the data obtained from the information technology components required for policy compliance.

12. The system of claim 11, wherein the policy report identifies the information technology components that are compliant or non-complaint with the policy.

13. The system of claim 10, wherein the information technology components are part of an information technology infrastructure.

14. The system of claim 10, wherein the information technology infrastructure is a data center.

15. A non-transitory processor readable medium, the non-transitory processor readable medium comprising machine executable instructions, the machine executable instructions when executed by a processor causes the processor to:
identify a policy requiring compliance;
identify, from the policy, information technology components required for determining policy compliance;
obtain data from the information technology components; and
analyze the data for determining compliance of the policy.
